(19) United States
(12) Patent Application Publication
(10) Pub. No.: US 2019/0064310 A1
(43) Pub. Date: Feb. 28, 2019

(54) METHODS AND APPARATUS FOR ACQUIRING AND TRACKING A PROJECTILE

(71) Applicant: MEGGITT TRAINING SYSTEMS, INC. (MTSI), SUWANEE, GA (US)

(72) Inventors: WENLONG TSANG, ALPHARETTA, GA (US); SCOTT A. BILLINGTON, SUWANEE, GA (US); RICHARD STUBER, JASPER, GA (US); CHRSTOPHER BONZZONE, SUWANEE, GA (US); BOBBY CHUNG, ATLANTA, GA (US)

(21) Appl. No.: 15/691,706

(22) Filed: Aug. 30, 2017

(51) Int. Cl. G01S 3/786; H04N 5/33; H04N 5/225; H04N 5/247

(52) U.S. Cl. CPC G01S 3/7864; H04N 5/247; H04N 5/2256; H04N 5/33

(57) ABSTRACT

A system for displaying a plurality of targets and detecting the path of a projectile is provided. In a preferred embodiment, the system comprises an enclosed space with a plurality of walls wherein the walls are coated with an anti-reflective coating; a screen for displaying a plurality of targets within the enclosed space; a first area scan camera and a second area scan camera positioned on a first side of the screen, wherein the first area scan camera is positioned at a first corner of the screen and is looking at a detection zone in front of the first side of the screen and the second area scan camera is positioned in an adjacent second corner and is looking at the detection zone; a first directional light source that spans a length of the screen and is positioned outside a field of view of the first area scan camera and second area scan camera, wherein the first directional light source is directed to project light across the first side of the screen through the detection zone.

### FIELD

The present patent document relates generally to detecting and determining the path of a projectile. More specifically, the present patent document relates to methods and apparatus for optically acquiring and determining the paths of fired ammunition such as bullets in a firing range.

### BACKGROUND

There are numerous proposed methods for detecting and determining the paths of projectiles. There are even numerous patents and patent applications proposing methods for detecting projectiles. However, the applicant of this application has discovered there is a big difference between a proposed theoretical way for detecting projectiles and implementing a projectile acquisition system that actually works. Applicant has found through extensive testing that many of the proposed systems are theoretical and in actuality, do not work effectively. To this end, the Applicant proposes in this application an optical detection system for detecting and determining the path of a projectile. In particular, Applicant's systems and methods are designed for detecting and determining the path of bullets shot from a firearm. Typical implementations of Applicant's embodiments may be in firing ranges or live fire simulators. Of course, other applications may be implemented without deviating from the scope or intent of this disclosure.

There are existing systems that can detect live fire and determine information about the ballistics of the rounds such as its origin, potential destination, speed, path etc. Traditionally, these systems for measuring bullet locations were acoustic based. Such systems are available from Polytonic™ or Sius Ascor™. These systems consist of a rubber screen (for projecting the image) with a compartment behind the rubber screen that has several microphones at the perimeter. Shot locations are detected by analyzing the time delay of the shot impacts and performing multilateration. These systems are expensive and difficult to make accurate. These systems also require heavy steel protection on all sides of the target to prevent the microphones from being damaged by the gunfire.

There is an optical system commercially available for bullet detection sold by AIS and Newton Labs as Model 1310—Live Bullet Tracker. The Model 1310 uses a structured light line on a frame surrounding the target. A line scan camera was configured to aim at the line of light. When a bullet passed in front of the light line and shadowed it, this was observed by the high-speed line scan camera. Although this system has many deficiencies, one major deficiency is the requirement of a frame, which limits the size of the screen. Moreover, detecting projectiles in a plane is imprecise and inconsistent. Accordingly, systems that can detect projectiles in a volume of space and do not require a frame around the screen are preferable.

### SUMMARY OF THE EMBODIMENTS

The embodiments of the present patent document provide methods and systems for displaying a plurality of targets and detecting the path of a projectile. The systems are designed to eliminate, or at least ameliorate, the deficiencies of the prior systems. In one aspect of the inventions taught herein, a method for detecting a bullet in a live fire simulator is provided. The method comprises: displaying a plurality of targets on a screen; scanning a detection zone in front of the screen with a first area scan camera that has a first array detector and an almost zero pipeline delay; scanning a detection zone in front of the screen with a second area scan camera that has a second array detector and an almost zero pipeline delay; reducing a scanned area of the first array detector and the second array detector such that the first area scan camera and the second area scan camera have a frame rate greater than or equal to 5000 frames per sec; filtering the light entering the first array camera with a first band-pass filter that allows light with a first range of wavelengths to pass into the first area scan camera; filtering the light entering the second array camera with a second band-pass filter that allows light with the first range of wavelengths to pass into the second area scan camera; illuminating the detection zone with a directional light source that illuminates the detection zone with light within the first range of wavelengths; detecting the bullet passing through the detection zone by detecting a trace of the bullet from the output of the first area scan camera and second area scan camera.

In some embodiments additional lights sources may be added and the method may further comprise illuminating the detection zone with a second directional light source and a third directional light source that both illuminate the detection zone with light within the first range of wavelengths. In preferred embodiments, the light source is a directional light bar. In yet other embodiments, the light source is comprised of a plurality of light bars or a light bar with a plurality of rows of LEDs.

In different embodiments, the cameras and light sources may be located in different places around the detection zone. In preferred embodiments, the light source, first area scan camera and second area scan camera are all mounted above the screen and are directed downwards.

In a preferred embodiment, the frame rate for the first and second area scan cameras is between 15,000 frames per sec and 25,000 frames per second. In yet other embodiments, the frame rate is between 5,000 frames per sec and 50,000 frames per second.

Sensitivity of the cameras at the chosen wavelength may also be an important factor. In a preferred embodiment, the first array detector and second array detector have a quantum efficiency of at least 35% within the first range of wavelengths.

In order to increase the frame rate, area scan cameras are also run in reduced area mode. To this end, the first area scan camera and second area scan camera may both be reduced to use at least 16 lines on the reduced axis. In other embodiments, more or less lines may be used. Ideally, the size of the array is reduced in order to increase the frame rate above 5000 frames per second. Accordingly, in some embodiments, the scanned area of the first and second area scan camera is reduced by 90% or more.

In some embodiments, a deflector coated in anti-reflective coating is placed on the opposite side of the screen from the cameras. The deflector may be angled and is preferably angled at 45 degrees to the screen.

In yet another embodiment, a method for detecting a projectile is provided. The method preferably comprises: displaying a plurality of targets on a screen; scanning a detection zone in front of the screen with a first area scan camera that has a first array detector and an almost zero pipeline delay; scanning a detection zone in front of the screen with a second area scan camera that has a second array detector and an almost zero pipeline delay; reducing a scanned area of the first array detector and the second array detector such that the first area scan camera and the second area scan camera have a frame rate greater than or equal to 10,000 frames per sec. filtering the light entering the first array camera with a first band-pass filter that allows light with a first range of wavelengths to pass into the first area scan camera; filtering the light entering the second array camera with a second band-pass filter that allows light with the first range of wavelengths to pass into the second area scan camera; illuminating the detection zone with a directional light source that illuminates the detection zone with light within the first range of wavelengths; placing a deflector with an anti-reflective coating across the screen from the light source; and detecting the bullet passing through the detection zone by detecting a trace of the bullet from the output of the first area scan camera and second area scan camera.

In another aspect of the inventions taught herein, a system for displaying a plurality of targets and detecting the path of a projectile is provided. The system preferably comprises: an enclosed space with a plurality of walls wherein the walls are coated with an anti-reflective coating; a screen for displaying a plurality of targets within the enclosed space; a first area scan camera positioned on a first side of the screen, wherein the first area scan camera is positioned at a first corner of the screen and is looking at a detection zone in front of the first side of the screen; a second area scan camera positioned on a first side of the screen in an adjacent second corner and looking at the detection zone; a first directional light source that spans a length of the screen and is positioned outside a field of view of the first area scan camera and second area scan camera, wherein the first directional light source is directed to project light across the first side of the screen through the detection zone.

Not all the embodiments need to be built inside with anti-reflective coated walls. Some embodiments may be constructed outside. In these types of embodiments, no walls need be present. If walls are present, they may be coated with an anti-reflective coating similar to the embodiments constructed.

In preferred embodiments, the systems may be used in live fire simulators to detect the bullets fired by trainees. In such systems, a projector is used to display the plurality of targets on the screen and the trainees are required to acquire the targets, often make decisions between friendly or foe, and then fire and hit the targets when expected. The systems herein can detect the bullets fired by the trainees, determine the ballistics of the bullet and provide feedback to the trainee. The feedback can be in many forms such as impact marks displayed on the screen, scoring, or a simulation that changes based on where the bullets landed on the projected image.

In some embodiments, the system may further comprise more light sources. For example, in some embodiments, a second light source and a third light source may be used. In some of those embodiments, the second light source is positioned on the first side of the screen in the first corner outside the field of view of the first area scan camera and the third light source is positioned on the first side of the screen in the second corner outside the field of view of the second area scan camera. In various different embodiments, many lights with different illumination vectors may be used. As many lights as need may be used to illuminate the bullet sufficiently for the cameras to detect bullets on all regions of the screen, and be tolerant to bullet angle of incidence.

In different embodiments, many different kinds of light sources may be used. In some embodiments, the light source is a directional light bar. Although the lights source is referred to in a singular sense, in some embodiments the light source is comprised of a plurality of light bars. In order to work effectively, the light should be within the wavelength of the camera's band-pass filter.

In preferred embodiments, the light source, first area scan camera and second area scan camera are all mounted below the screen and are directed upwards. However, in other embodiments they may be mounted above the screen and directed down or mounted on either side of the screen and directed across. However, it is important that the light source be mounted on the same side and behind the area scan cameras so that the light from the light source does not flood the sensors of the area scan cameras. To this end, some embodiments mount the light source, first area scan camera and second area scan camera on the same mounting rail.

Although systems can work with only two area scan cameras, additional cameras can increase the performance. In some embodiments, a third area scan camera is located on the first side of the screen between the first area scan camera and second area scan camera and looks at the detection zone. In other embodiments, four, five, six or more area scan cameras may be used.

### BRIEF DESCRIPTION OF THE DRAWINGS

FIG. 1 illustrates one embodiment of a system for detecting a projectile in a live fire system.

FIG. 2 illustrates another embodiment of a system for detecting a projectile in a live fire system.

FIG. 3 illustrates an actual light bar used across the bottom of a bullet detection system.

FIG. 4 illustrates a portion of the detection system of FIG. 1 with a camera field of view and projectile trace illustrated for discussion.

### DETAILED DESCRIPTION OF THE PREFERRED EMBODIMENTS

Detecting a bullet passing through a volume and determining the ballistic characteristics of the bullet including the starting and ending locations along with the trajectory are difficult problems to solve. One immediately thinks of needing incredibly high-speed equipment to try and measure the bullet passing through the volume. For example, if a person is trying to photograph a bullet with a camera, it is understood that an incredibly fast shutter is needed to try and capture a bullet passing through a detection zone. Moreover, the bullet is passing so fast through the field of view, that the timing of the shutter would have to be incredibly precise so that the camera shutter is open exactly as the bullet passes through the field of view. This of course is an incredibly difficult problem to solve when the launch time of the bullet is random and unknown.

The embodiments herein use a completely different approach to bullet detection from the type of technique that would be used to try and photograph a bullet. Rather than an incredibly fast shutter with a very short exposure, the cameras are set up to continuously take in light. The detection zone is flooded with a particular wavelength of light and the cameras use band-pass filters to reduce their sensitivity to a narrow range of light around the wavelength flooding the detection zone. The frame rate of the camera is much slower than what would be needed to perform stop action photography of a bullet and the cameras detect the bullet path as a trace of reflected light across the camera detector. Accordingly, the cameras are configured to always be collecting light (so no bullets are missed), and lights illuminating the detection zone are bright enough to reflect enough light off the bullet as it passes through such that the bullets appear streaking through the image. To this end, the requirement to know the firing time of the bullet and the requirement for an incredibly fast camera are eliminated. If the right types of cameras are used and arranged in the correct configuration, enough information can be obtained from the images of the streak of the bullet to locate the path of the bullet in three-dimensional space. From the three-dimensional knowledge of the path of the bullet through the detection zone, the starting and ending point of the bullet can be predicted.

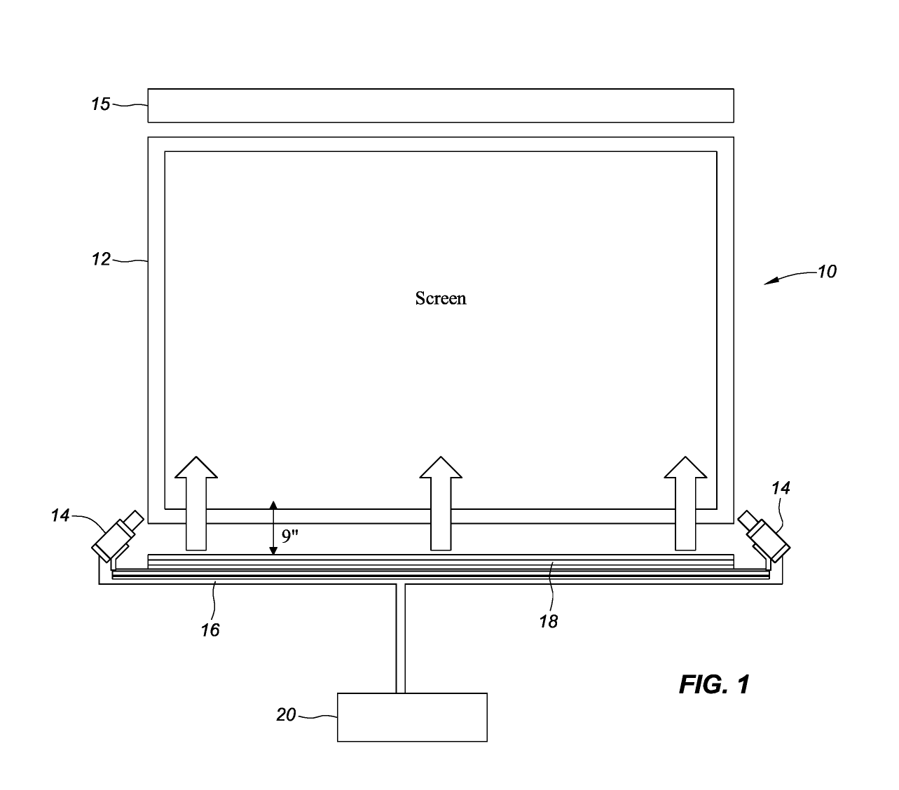

FIG. 1 illustrates one embodiment of a system for detecting a projectile in a live fire system. As shown in FIG. 1, the system may include a screen 12. The screen 12 is provided to provide projections of targets. Targets may be moving or stationary. Targets are typically projected on to the screen using a projection system. However, the screen 12 might also be a static target, or plurality of static targets, printed on the surface of some paper. The main purpose of the screen is to provide an aim point.

In use, trainees see the images on the screen and fire live ammunition at the screen. The accuracy and decision making of the trainee may be calculated by the system and provided to the trainee as feedback. In order to determine the accuracy of trainee's firing, the system acquires, tracks and calculates the trajectory of the projectile fired from the trainee's weapon, typically a bullet. The system may calculate the aim point and hit point based on this information. Generally, the information of the trainee's projectile will be referred in totality as ballistic data.

In order to detect the shot, acquire the projectile and calculate the ballistic data of the projectile, the present system uses a number of components configured in very specific ways. In front and below the screen 12 are cameras 14 and lights 18. In the embodiments used herein, the cameras 14 are area scan cameras running in a reduced area mode. As used herein, “area scan camera” means a camera with a sensor that includes a planar array of pixels consisting of multiple lines. In preferred embodiments, area scan cameras that can be configured for a reduced number of lines, with a faster scan rate than would be possible of the whole area are used. When multiple area scan cameras are aimed at the same space, mounted at known different vantage points, the three-dimensional position of objects in the space can be measured.

In preferred embodiments, the area scan cameras are run in a reduced area mode and in some cases a significantly reduced area mode. As one example, a camera with a resolution of about 2048×1086 may be reduced to a resolution of 2048×16 and scanned at 20,000 frames per second. Accordingly, in this embodiment, the lines of the array have been reduced to 16 from 1086 or reduced by 98.5%. The number of lines of the array that may be used may vary but is preferably between 1 and 64 lines, and even more preferably between 8 and 16 lines. To this end, the scanned area of the area scan camera may be reduced by 90% or more. In some embodiments, the scanned area of the area scan camera may be reduced by 95% or more and may even be reduced by as much as 98% or even 99%.

Numerous references teach away from the use of area scan cameras. For example, U.S. Pat. No. 7,335,116 and U.S. Pat. No. 7,650,256 both suggest that area scan cameras are too slow for such applications and should not be used. In general, area scan cameras are not considered suitable for detecting fast moving objects and are thus, not an obvious solution to the problem of projectile detection, especially bullet detection.

However, Applicant has appreciated that area scan cameras running in a reduced area mode, or with a small number of lines in the array, are not too slow for bullet tracking provided the correct illumination is provided in the correct areas and configured as discussed and taught herein.

In addition to running the cameras in a reduced area mode, it is also important that the cameras have a small or zero pipeline delay so the cameras can collect light continuously or near continuously. Even though a bullet transits the detection zone quickly, if there is enough reflected light, the camera detects it as a bright streak through the image. However, if the cameras are not continuously collecting light, a bullet transit may be missed. To this end, the embodiments herein use two or more area scan cameras 14 with very little or zero pipeline delay and running in a reduced area scan mode. The term “almost zero pipeline delay” as used herein is meant to mean that no sensor is dark for long enough for a bullet to pass through the detection zone undetected by the cameras. This of course varies depending on the speed of the bullet and width of the detection zone and one skilled in the art will appreciate the acceptable amount of pipeline delay can vary accordingly.

In preferred embodiments, the cameras 14 are placed in opposite corners of one side of the screen 12. This may be in front or behind the screen 12. Keeping all the cameras 14 on one side of the screen 12 enables only one side of the screen 12 to need protection. One example of an acceptable area scan camera 14 is the model JC3000 from JFT found at www.jftinc.com. Other area scan cameras can be substituted without departing from the scope of the inventions claimed herein.

In preferred embodiments, a deflector 15 is placed on the same side of the screen 12 as the cameras 14 but across the screen 12 from the cameras 14. The deflector 15 is designed to discard the light from the lights 18, or other ambient light, such that it does not reflect back into the cameras 14. This creates a darker background for the cameras 14 to view and reduces noise and thus, increases the signal to noise ratio. In preferred embodiments, the deflector 15 is coated with an anti-reflective coating to further reduce any reflected light into the cameras 14. In addition, the deflector 15 may be placed at an angle with respect to the screen 12 and the cameras 14 such that any light that is reflected is reflected away from the field of view of the cameras 14. In a preferred embodiment, the deflector 15 is placed at a 45-degree angle to the screen 12. However, other angles may be used including 40, 30 or 20 degrees.

The field of view of the cameras 14 is typically set to a 90-degree wide (looking from the corner) by 3-5 degree wide window just in front of the screen 12. The 90-degree field of view is the field of view in the x-y plane of the screen (vertical and horizontal planes of the screen). The 3-5 degree field of view is in the z direction of the screen (into and out of the plane of the screen). In preferred embodiments, the cameras 14 are angled upwards from the ground looking into the volume just in front of the screen 12. In other embodiments, the cameras 14, may be on the top of the screen looking toward the ground. In yet other embodiments, the cameras 14 may be on the sides of the screen 12 looking across. As may be appreciated, combinations of different camera positions may also be used. Each camera is set to overlap the same volume in their field of view. The cameras 14 are angled outward from the screen 12 so that the cameras' volume is in front of the screen 12. By not having the projection screen 12 in the field of view, reflected illumination from the screen 12 is prevented from entering the cameras 14. Due to trigonometry, the triangulation used to calculate the bullet ballistics is more accurate in the space further from the cameras and becomes less accurate when the two cameras 14 are staring at each other. Accordingly, in embodiments where shooters may be shooting laying down or close to the ground, it is advantageous to place the cameras above the screen, on the top looking down, in order to have a higher precision close to the ground.

The cameras 14 are equipped with narrow band-pass filters. The band-pass filters block out all the light except light from a particular wavelength. The wavelength the cameras allow is then matched to the wavelength of the lights 18 being used. In preferred embodiments, a “narrow” band-pass filter means the filter has a range of about 300 nanometers or less. In an even more preferred embodiment, the band-pass filter has a range of about 150 nanometers or less. Even more preferably, the band-pass filter has a range of 50 nanometers or less.

The embodiments for projectile detection taught herein can be constructed to use any wavelength of light for the lights and the detectors/band-pass filters. The key is that the lights and detectors/band-pass filters are matched to the same wavelength. Although the system can be designed to detect at any wavelength, the near infrared has been found to be preferable. This is because the near IR is out of the visible range and thus is not seen by the participants. Moreover, the near IR will not interfere with projected targets, which are in the visible range. In addition, the interference from any light of the projected targets on the projectile detection system will be minimized.

To this end, in preferred embodiments, the cameras 14 and their respective band-pass filters are set to be in the range of 700 nanometers to 2500 nanometers. In a preferred embodiment, a wavelength at or around 850 nanometers may be used. Other ranges may be selected based on the availability of light sources and camera sensitivity. Selecting a wavelength that is not directly in the visible wavelength is important because otherwise the detection pixels of the cameras 14 could be easily saturated with ambient visible light, visible light from the projection screen, or other visible light coming from scatter or noise and therefore, not allow reflected light from the bullet to be detected. Visible light would also disturb the image quality of the projected image.

The cameras must also be of the type that uses a shutter exposure setting with a zero-pipeline delay i.e. the cameras never enter a mode where they are not collecting light. Even if this time were short, the bullet transit time is very fast and detection could be missed.

A global shutter is the technical term referring to sensors that scan the entire area of the image simultaneously. Global shutters are contrasted by rolling shutters which scans the sensor sequentially, usually from one side to the other. The preferred embodiment is to have a camera with a global shutter and zero pipeline delay. However, rolling shutters can be used as long as every line has no dead time in which it is not collecting light.

In most cases, the bullet transit time is much less than the camera frame exposure time. But, because the bullet passes through the camera image, reflecting light the whole time, it puts a light streak into the image. Capturing the path of the projectile is similar and uses the same principle as capturing an illuminated tracer round or a shooting star on a photograph. In a traditional photographic setup, a person would be concerned about having a high-speed camera trying to “freeze” the frame of the bullet. The proposed systems herein operate differently from the traditional setup and are not trying to do stop-action photography. Instead, the shutter is set to digitally always be collecting in a continuous pipeline. In the continuous pipeline, the pixels are always collecting light and recording it. The received light quantity is “copied” off to make an image, but the collector is always on. Accordingly, the camera does not see a bullet, it sees the streak from a bullet.

It is important to try and maximize the signal to noise ration of the system. In order to do so, the sensitivity of the cameras at the chosen wavelength is important. The more sensitive the camera, the less light needed and vice versa. Sensitivity is a key performance feature of any detection system. When assessing the sensitivity of any detector it is the achievable Signal-to-Noise Ratio (SNR) which is of key importance. The approach to ensure the best possible SNR ratio is to a) use a sensor with the highest possible quantum efficiency and b) reduce the various sources of noise to a minimum. Quantum Efficiency (QE) is related to the ability of the sensor to respond to the incoming photon signal and the conversion of it to a measurable electron signal. Clearly, the greater the number of photoelectrons produced for a given photon signal the higher the QE. QE is usually expressed as a probability—typically given in percentage format—where for example a QE of 0.6 or 60% indicates a 60% chance that a photoelectron will be released for each incident photon. QE is a wavelength or photon energy dependent function, and a sensor is generally chosen which has the highest QE in the wavelength region of interest. As just one example, sensors with a QE of 65% at 650 nm and 38% and 850 nm have been successfully used. However, whatever wavelength is selected for the system, maximizing the sensitivity of the cameras and their respective detectors will increase the SNR and make bullet detection easier.

Another important aspect for signal to noise ratio is the frame rate of the cameras. Although the cameras are continuously collecting light, they must still be set to determine the dwell time that each image is created from. The frame rate will determine the saturation of the pixels by ambient light with wavelengths in our region of interest. If the frame rate is set too low, the pixels will be saturated with a minimum amount of light and the bullet will not be able to be detected above the noise. In order to increase the frame rate to an acceptable level, an area scan camera may need to have the scanned area of the array detector reduced. By reducing the number of lines that need to be scanned in any one frame, the frame rate of the area scan camera may be sped up. Of course, there may exist area scan cameras that already have a frame rate fast enough. If none exist, advances in technology may certainly create such area scan cameras. Accordingly, and if none exist, the future might bring such technologies to the market. Accordingly, the step of reducing a scanned area of an array detector is meant to encompass selecting an area scan camera with an acceptable frame rate to begin with.

In preferred embodiments, a scanned area of the array detectors of the area scan cameras is reduced such that the area scan cameras have a frame rate between 5000 frames per sec and 30,000 frames per second. In even more preferred embodiments, the frame rate of the area scan camera is between 15,000 and 25,000 and even more preferably between 19,000 and 21,000 frames per second. As one example, a 2048×1016 camera has an area reduction down to 2048×16 and is run at 20,000 frames per second.

Each of the camera's outputs is hooked up to a real-time bullet tracking processor or processors 20. The real-time processors analyze the output from the cameras and determine when a bullet or projectile has crossed through the field of view. There are many known methods of determining the location of the light detected from the bullet and the only analysis is to determine if the light detection is actually a bullet or noise. There are numerous common filtering algorithms that can work to help separate the noise or false light from the actual bullet path.

Prior to operation, the coordinate space of the camera is registered/calibrated to the physical space of the projected screen with trigonometry and an interpolation algorithm. As just one example, an X is projected on the screen and a pencil is used to “poke at the X” producing a similar signature to a bullet. This way the coordinates of the camera frame of reference and the projected image frame of reference are matched. This process is repeated at multiple points around the screen to fine calibrate the cameras to the projected target image.

Essentially, the challenge is to detect a fast-moving bullet and discriminate it from the surroundings. For example, a piece of dust close to one camera can be as bright as a bullet. However, dust does not move fast, and doesn't stretch across the entire detection volume. Accordingly, using a multiple line array is actually advantageous over a single line detector because false positives can be more easily eliminated. On an area scan detector, a bright spot that is a projectile can be confirmed by making sure it spans multiple lines of the detector array. In a preferred embodiment, the threshold may just be multiple lines however, a majority of the lines or even a complete transit of the array may be required to confirm a transit of a projectile. Obviously, this technique is not possible using a single line array and accordingly, it is much easier to get dust or other contaminates as false positives.

In order to perform a better image analysis, a scan of the detection zone may be used as a threshold to identify those pixels that are bright. Accordingly, when the system begins looking for bullets passing through the detection zone, bright pixels that are stationary and/or known can be ignored. Those pixels that are bright and transit the detection volume are determined to be from a projectile.

Once the bullet transit through the detection volume is confirmed by the image analysis, it is simple math to combine the data from both cameras, calculate the coordinates of the bullet transit and the coarse direction vector of the bullet.

In addition to the cameras 14, it is essential that the correct lighting is used. A light source 18 is chosen to be at a wavelength inside the range of the band-pass filter of the cameras. In preferred embodiments, the wavelength of the light source is near the middle of the range of the band-pass filter on the camera.

It is important for the lights to be quite powerful in order to reflect enough light back into the cameras to be detected. In a preferred embodiment, at least 3 watts of LED powered light per square foot of detection area is used. In an even more preferred embodiment, 4.375 watts of LED powered light per square foot of detection area is used. In other embodiments between 3 and 5 watts of LED powered light per square foot of detection area is used. In one embodiment, a 10-foot-wide by 8-foot-high screen was used in combination with 288, 3-Watt LEDs configured in a light bar across the 10-foot width of the top of the screen pointing down. The light bar was powered by 350 Watts such that the ratio was 35 watts per linear foot of screen (with an 8-foot height). Each LED was equipped with a 5-7 degree beam width lens to focus the energy downward.

Another requirement is the placement and position of the lights. The lights 18 must not shine directly into the cameras' 14 field of view, or they saturate the detector rendering it blind at those pixels. Accordingly, in the embodiment in FIG. 1, a lightbar 18 is used and the light is directed vertically. The lightbar of FIG. 1 is a highly directional lightbar such that the light is directed vertically with very little light escaping directly into the aperture of the lenses of the cameras 14.

In the embodiment of FIG. 1, the light bar 18 extends almost the entire length between the first and second cameras 14 positioned on the corners of the screen 12. In some embodiments, baffles may be used around the light source 18 to reduce scatter into the cameras 14. Although a lightbar is shown as the light source 18 in FIG. 1, other types of lights may be used as the light source 18. For example, flood lights, spot lights, bulb lights, LEDs or any other type of light may be used as long as the wavelength is matched to the band-pass filter. Lights with reduced scatter are preferred. Baffling and/or directional reflectors may be used to help reduce scatter and flood the area of interest with light.

The lights 18 are preferably placed above or below the screen. In the embodiment of FIG. 1, the top of the lights 18 are 9 inches below the screen.

Even if the entire configuration from above was followed, it is often still not enough to consistently acquire and track the projectile and produce satisfactory results. Though basic detectability in some regions is achievable, small angles (less than 7 degrees) of incidence of the bullet relative to the screen orthogonal, remain very difficult to detect. This is largely because the bullet is dirty, engraved by barrel rifling, and the reflection is specular.

Because the reflection of the bullet/projectile is specular, it is important to reduce background noise as much as possible. Even with the narrow band-pass filters, the background reflections can give signals back to the detector on the order of the brightness expected from the bullet. To this end, the signal to noise ratio of the bullet to the background is very weak and false positives are continuously detected. However, applying anti-reflective coatings to the walls reduces the background noise and helps reduce false positives. To this end, embodiments herein may be created in a large room with walls that are coated in an anti-reflective coating.

In addition to applying an antireflective coating to the walls, the cameras may also be baselined to set a minimum threshold for detection. Setting the baseline for the cameras above the background noise will help prevent background noise as appearing to the camera as a projectile. To this end, a measure can be made of the baseline pixel intensity with the lights on and no bullets. Once the baseline is attained, it may be subtracted out during operation. This helps create a uniform threshold to detect the bullet.

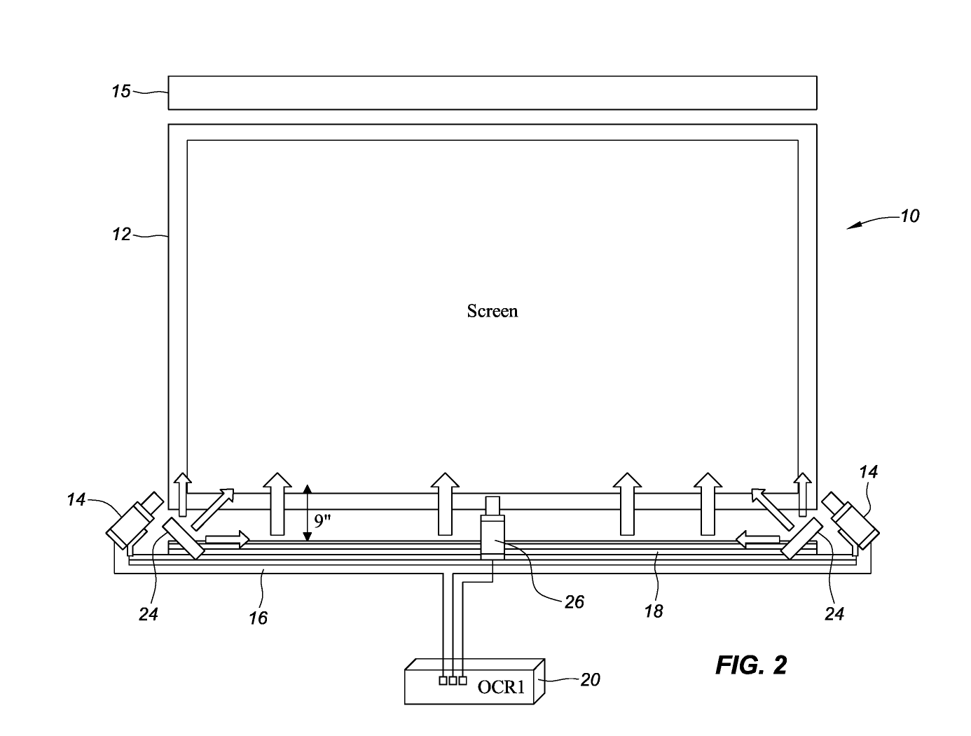

FIG. 2. illustrates another embodiment of a system for acquiring and determining the path of a projectile. The embodiment of FIG. 2 is similar to the embodiment of FIG. 1 except FIG. 2 includes additional cameras and lights, as will be described in more detail below.

Although a highly direction lightbar is a great choice for light source 18, it was determined that projectiles impacting the corners of the screen, or portions of the screen near the corners of the light bar, were still difficult to detect. Accordingly, in some embodiments, additional lights were added. As may be seen in FIG. 2, additional light sources 24 were added below the screen and below the cameras 14. Each of the additional light sources 24 were directed to aim their light on the corners of the screen and away from the proximal camera 14. In addition, for providing additional illumination for the corners, these additional light sources provide illumination from a different angle throughout the detection zone. Additional light from an additional angle helps illuminate any projectiles crossing through the detection zone more thoroughly and increases the signal therefrom. To this end, if a light bar as used as the primarily light source 18, it is recommended that at least one additional light source 24 be used to provide additional illumination at an angle different from that of the light bar. In preferred embodiments, at least two additional light sources may be used and they may be placed in each corner illuminating back towards the center of the screen. In yet other embodiments, a non-uniform lightbar may be used with more lights on the corners. In one embodiment, the light bar was doubled up along the entire length and tripled up at the corners nearest the cameras.

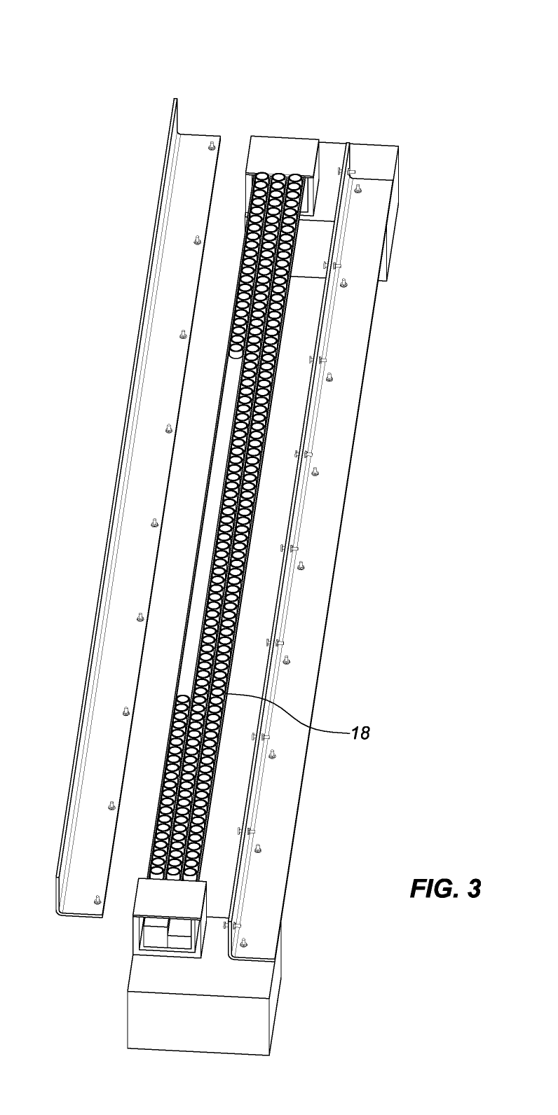

FIG. 3 illustrates an actual light bar 18 used across the bottom of a bullet detection system. As may be seen, the light bar consists of hundreds of individual LEDs. In this case 288 3-Watt LEDs each with a focus lens. The light bar is two LEDs deep across its entire 10-foot length and 3 LEDs deep on the corner. The extra LEDs on the corner help illuminate the corners as suggested is required for better detection above.

Along with additional light sources, it may also be advantageous to include additional cameras 26. As may be seen returning to FIG. 2, additional cameras 26 may be used along with the cameras 14 placed in each corner. In the embodiment shown in FIG. 2, the additional camera is located in the middle of the screen and directed vertically in front of the screen to overlap the detection zone with the other two cameras 14. Although only a single additional camera 26 is shown in FIG. 2, any number of additional cameras 26 may be used. Preferably, the cameras 26 are spaced to reduce the distance between any one camera and the next successive camera. Each camera overlapping the detection zone with its field of view.

In operation, the output from each camera may be cross-referenced with the output from at least one other camera to confirm a projectile detection. To this end, adding additional cameras 26 to the system may help prevent false detections.

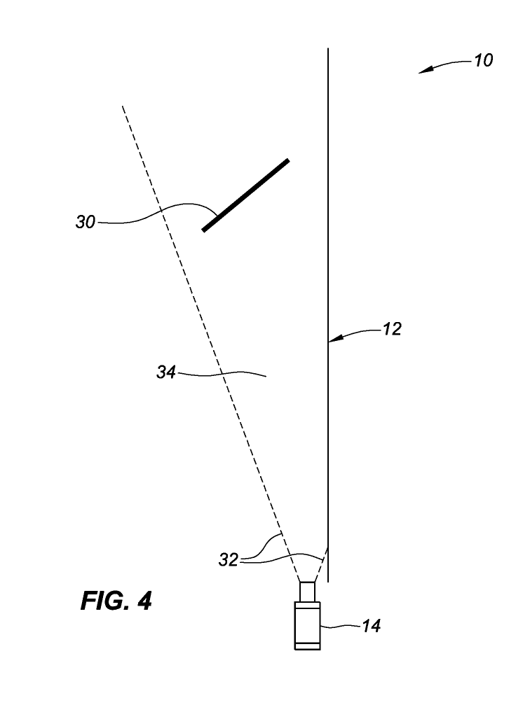

FIG. 4 illustrates a portion of the detection system 10 with a camera field of view 32 and projectile trace 30 illustrated for discussion. As the projectile crosses through the overlapping cameras' fields of view 32, the projectile trajectory is captured by the cameras as a flash of light across the sensors. This is of course light from the light sources 18 reflected back into the cameras 14 by the projectile. From the streak of light, the vector of the projectiles path is calculated. The vector may then be extended to project the impact location on the screen. If a projection system is used, the projection system may actually insert an impact location for display onto the screen. In preferred embodiments, the impact location may be exaggerated in size so that it is easily visible by the trainee.

One advantage to using an area scan camera is that unlike a line scan camera, the adjustable region of interest “ROI” of the smart area (a.k.a. detection zone) allows the scan camera to detect the projectile in a volume of space instead of just a plane. Being able to detect the projectile in a volume instead of just a plane not only increases the chance of bullet detection, it also allows the calculation of the trajectory of the projectile based on its “vector trace” in the tracking volume or detection zone. Calculating a projectile's ballistics based on a trace instead of points in a plane is much simpler. Moreover, the vector may be extended rearward to calculate the origin of the shooter for accurate ballistic calculation on the center and edges of the screen. Accordingly, for small screen sizes, only two cameras may be needed.

Although the invention has been described with reference to preferred embodiments and specific examples, it will readily be appreciated by those skilled in the art that many modifications and adaptations of the methods and devices described herein are possible without departure from the spirit and scope of the embodiments as claimed hereinafter. In addition, elements of any of the embodiments described may be combined with elements of other embodiments to create additional embodiments. Thus, it is to be clearly understood that this description is made only by way of example and not as a limitation on the scope of the claims below.

What is claimed is:

1. A method for detecting a bullet in a live fire simulator comprising:
displaying a plurality of targets on a screen;
scanning a detection zone in front of the screen with a first area scan camera that has a first array detector and an almost zero pipeline delay;
scanning a detection zone in front of the screen with a second area scan camera that has a second array detector and an almost zero pipeline delay;
reducing a scanned area of the first array detector and the second array detector such that the first area scan camera and the second area scan camera have a frame rate greater than or equal to 5000 frames per sec;
filtering the light entering the first array camera with a first band-pass filter that allows light with a first range of wavelengths to pass into the first area scan camera;
filtering the light entering the second array camera with a second band-pass filter that allows light with the first range of wavelengths to pass into the second area scan camera;
illuminating the detection zone with a directional light source that illuminates the detection zone with light within the first range of wavelengths;
detecting the bullet passing through the detection zone by detecting a trace of the bullet from the output of the first area scan camera and second area scan camera.

2. The method of claim 1, further comprising illuminating the detection zone with a second directional light source and a third directional light source that both illuminate the detection zone with light within the first range of wavelengths.

3. The method of claim 1, wherein the light source is a directional light bar.

4. The method of claim 3, wherein the light bar is comprised of hundreds of LEDs in rows along a length of the light bar with at least one additional row used at each end of the light bar.

5. The method of claim 3, wherein the light source is comprised of a plurality of light bars.

6. The method of claim 1, wherein the light source, first area scan camera and second area scan camera are all mounted above the screen and are directed downwards.

7. The method of claim 1, further comprising scanning a detection zone in front of the screen with a third area scan camera.

8. The method of claim 1, wherein the first range of wavelengths is in the near infrared.

9. The method of claim 1, wherein the frame rate is between 15,000 frames per sec and 25,000 frames per second.

10. The method of claim 1, wherein the first array detector and second array detector have a quantum efficiency of at least 35% within the first range of wavelengths.

11. The method of claim 1, wherein the first area scan camera and second area scan camera both use at least 16 lines on a reduced axis.

12. The method of claim 1, wherein the scanned area of the first and second area scan camera is reduced by 90% or more.

13. The method of claim 1, further comprising placing a deflector coated in anti-reflective coating on the opposite side of the screen from the cameras.

14. The method of claim 13, wherein the deflector is angled at 45 degrees to the screen.

15. A method for detecting a projectile comprising:
displaying a plurality of targets on a screen;
scanning a detection zone in front of the screen with a first area scan camera that has a first array detector and an almost zero pipeline delay;
scanning a detection zone in front of the screen with a second area scan camera that has a second array detector and an almost zero pipeline delay;
reducing a scanned area of the first array detector and the second array detector such that the first area scan camera and the second area scan camera have a frame rate greater than or equal to 10,000 frames per sec.
filtering the light entering the first array camera with a first band-pass filter that allows light with a first range of wavelengths to pass into the first area scan camera;
filtering the light entering the second array camera with a second band-pass filter that allows light with the first range of wavelengths to pass into the second area scan camera;
illuminating the detection zone with a directional light source that illuminates the detection zone with light within the first range of wavelengths;
placing a deflector with an anti-reflective coating across the screen from the light source; and
detecting the bullet passing through the detection zone by detecting a trace of the bullet from the output of the first area scan camera and second area scan camera.

16. The method of claim 15, further comprising illuminating the detection zone with a second directional light source and a third directional light source that both illuminate the detection zone with light within the first range of wavelengths.

17. The method of claim 15, wherein the light source is a directional light bar.

18. The method of claim 17, wherein the light source is comprised of a plurality of light bars.

19. The method of claim 15, wherein the light source, first area scan camera and second area scan camera are all mounted above the screen and are directed downwards.

20. The method of claim 1, further comprising scanning a detection zone in front of the screen with a third area scan camera.
